(19) United States
(12) Patent Application Publication
(10) Pub. No.: US 2014/0176824 A1
(43) Pub. Date: Jun. 26, 2014

(54) CONNECTION STRUCTURAL BODY OF TOUCH PANEL AND METHOD OF MANUFACTURING THE SAME

(71) Applicant: SAMSUNG ELECTRO-MECHANICS CO., LTD., Suwon (KR)

(72) Inventors: Young Jae Kim, Suwon (KR); Ho Joon Park, Suwon (KR); Seung Joo Shin, Suwon (KR); Ha Yoon Song, Suwon (KR)

(21) Appl. No.: 13/920,552

(22) Filed: Jun. 18, 2013

(30) Foreign Application Priority Data
Dec. 20, 2012 (KR) 10-2012-0149819

(51) Int. Cl. G06F 1/16

(52) U.S. Cl. CPC G06F 1/1692
USPC 349/12; 427/207.1; 427/58

(57) ABSTRACT

Disclosed herein is a touch panel. More particularly, the touch panel includes a pad portion connected with one portion of the touch panel and having each pad formed in one direction while including a separate space; an adhesive portion formed on a lower surface of the pad portion; and a molding portion formed on an upper surface of the pad portion. By this configuration, it is possible to contribute to miniaturization and thinness of the touch panel while improving durability of the touch pad.

### CROSS REFERENCE TO RELATED APPLICATION

This application claims the benefit of Korean Patent Application No. 10-2012-0149819, filed on Dec. 20, 2012, entitled “Connection Structural Body Of Touch Panel And Method Of Manufacturing The Same” which is hereby incorporated by reference in its entirety into this application.

### BACKGROUND OF THE INVENTION

1. Technical Field

The present invention relates to a connection structural body of a touch panel and a method of manufacturing the same.

2. Description of the Related Art

In accordance with the growth of computers using a digital technology, devices assisting computers have also been developed, and personal computers, portable transmitters and other personal information processors execute processing of text and graphics using a variety of input devices such as a keyboard and a mouse.

However, while the rapid advancement of an information-oriented society has widened the use of computers more and more, it is difficult to efficiently operate products using only a keyboard and a mouse currently serving as an input device. Therefore, the necessity for a device that is simple, has minimum malfunction, and is capable of easily inputting information has increased.

In addition, current techniques for input devices have progressed toward techniques related to high reliability, durability, innovation, designing and processing beyond the level of satisfying general functions. To this end, a touch panel has been developed as an input device capable of inputting information such as text, graphics, or the like.

This touch panel is mounted on a display surface of an image display device such as an electronic organizer, a flat panel display device including a liquid crystal display (LCD) device, a plasma display panel (PDP), an electroluminescence (El) element, or the like, and a cathode ray tube (CRT) to thereby be used to allow a user to select desired information while viewing the image display device.

Meanwhile, the touch panel is classified into a resistive type, a capacitive type, an electromagnetic type, a surface acoustic wave (SAW) type, and an infrared type. These various types of touch panels are adapted for electronic products in consideration of a signal amplification problem, a resolution difference, a level of difficulty of designing and processing technologies, optical characteristics, electrical characteristics, mechanical characteristics, environmental resistance characteristics, input characteristics, durability, and economic efficiency. Currently, the resistive type touch panel and the capacitive type touch panel have been prominently used in a wide range of fields.

As described in Patent Documents, researches into the miniaturization and thinness of the touch panel by applying a flexible printed circuit board to a touch panel have been actively conducted.

However, when a flexible printed circuit board is used as a connection structural body of a touch panel, the bonding strength of the connected part is weak, such that disconnection may be frequently caused. Further, the bonded part may be easily separated even in a weak physical impact from the outside.

Therefore, a method for improving the strength of the connected portion of the connection structural body of a touch panel is urgently required.

### PRIOR ART DOCUMENT

### Patent Document

(Patent Document 1) Korean Patent Laid-Open Publication No. 2006-0129980

### SUMMARY OF THE INVENTION

The present invention has been made in an effort to provide a connection structural body of a touch panel so as to secure the connection of the touch panel.

Further, the present invention has been made in an effort to provide a method of manufacturing a connection structural body of a touch panel so as to secure the connection of the touch panel.

According to a preferred embodiment of the present invention, there is provided a connection structural body of a touch panel, including: a pad portion connected with one portion of the touch panel and having each pad formed in one direction while including a separate space; an adhesive portion formed on a lower surface of the pad portion; and a molding portion formed on an upper surface of the pad portion.

The connection structural body may be a flexible printed circuit board (FPCB).

The pad portion may be alternately formed with a plurality of concave and convex shapes and one surface of the convex shape may be provided with the pad.

The pad portion may be formed of a conductive material.

The adhesive portion may use an anisotropic conductive film (ACF) or an anisotropic conductive adhesive (ACA).

The molding portion may be formed of epoxy.

The molding portion may be formed wider than an area of the pad portion so as to cover the entire upper surface of the pad portion.

The connection structural body of a touch panel may further include a pattern portion formed at an end of the pad portion and formed in a plurality of patterns.

The pattern may have a circular or oval shape.

The pattern may have a polygonal shape.

The pattern may be formed vertically or horizontally and may be formed in at least one column.

According to another preferred embodiment of the present invention, there is provided a method of manufacturing a connection structural body of a touch panel, including: (A) forming an adhesive portion on a lower portion of a pad; (B) forming a pad portion by stamping a separate region between the respective pads; and (C) forming a molding portion by applying a molding agent on an upper surface of the pad portion.

In the forming of the adhesive portion, the adhesive portion may use an anisotropic conductive film (ACF) or an anisotropic conductive adhesive (ACA).

In the forming of the pad portion, the pad portion may be alternately formed with a plurality of convex shapes in which the pad is formed and a plurality of concave shapes in which the space region is stamped.

In the forming of the pad portion may further include forming the pattern portion at a front end of the pad portion by removing the plurality of patterns and forming the pattern portion on a lower surface of the molding portion so as to be covered by the molding portion.

The pattern may have a circular or oval shape.

The pattern may have a polygonal shape.

The pattern may be formed vertically or horizontally and may be formed in at least one column.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exemplified diagram illustrating a connection structure of a touch panel according to a first preferred embodiment of the present invention;

FIG. 2 is an exemplified diagram illustrating in detail a connection structural body of a touch panel according to the first preferred embodiment of the present invention;

FIG. 3 is a cross-sectional view illustrating a cut surface of the connection structural body of a touch panel according to the first preferred embodiment of the present invention;

FIG. 4 is an exemplified diagram illustrating a touch panel according to a second preferred embodiment of the present invention;

FIG. 5 is an enlarged view illustrating in detail a connection structural body of a touch panel according to the second preferred embodiment of the present invention;

FIG. 6 is a cross-sectional view illustrating a cut surface of the connection structural body of a touch panel according to the second preferred embodiment of the present invention;

FIG. 7 is an exemplified diagram illustrating another pattern shape of a second pattern portion according to the second preferred embodiment of the present invention;

FIG. 8 is an exemplified diagram illustrating still another pattern shape of the second pattern portion according to the second preferred embodiment of the present invention; and

FIG. 9 is a flow chart sequentially illustrating a method of manufacturing a connection structural body of a touch panel according to a third preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention are described in detail with reference to the accompanying drawings.

In the specification, a “touch panel” is collectively referred to as electronic devices using a touch panel as an input unit and indicates a touch type cellular phone, a smart phone, a personal digital assistant (PDA), a personal multimedia player (PMP), car navigation, kiosk, home electronic instrument like TV, refrigerator, etc., a computer like tablet pc, and the like.

Further, in the specification, a separate space is a space formed by stamping a separate region of a connection structural body of a touch panel.

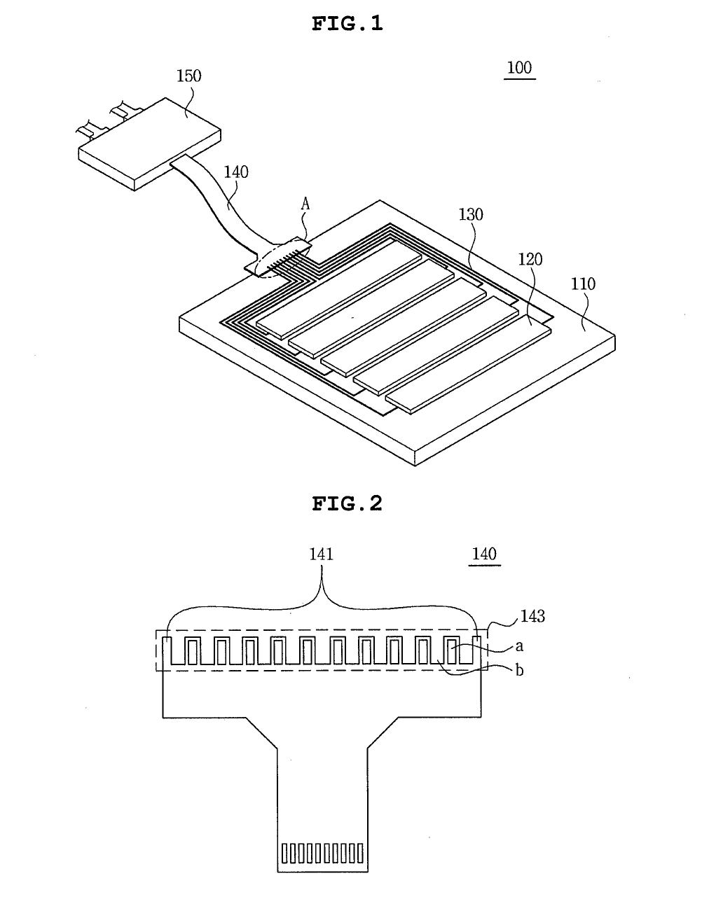

Like members of FIGS. 1 to 9 are denoted by like reference numerals.

A basic principle of the present invention is to improve connection strength of the touch panel by forming and molding a pad portion and a pattern portion in the connection structural body of a touch panel. Herein, the connection structural body of a touch panel is configured as a flexible printed circuit board.

Further, when it is determined that the detailed description of known functions and configurations related to the present invention in describing the present invention may obscure the gist of the present invention, the detailed description thereof will be omitted.

FIG. 1 is an exemplified diagram illustrating a connection structure of a touch panel according to a first preferred embodiment of the present invention.

Referring to FIG. 1, a touch panel 100 according to a first preferred embodiment of the present invention includes a transparent substrate 110, transparent electrodes 120 formed on an upper surface of the transparent substrate 110, signal wirings 130 that extend from the transparent electrodes 120 and are collected to one end of the transparent substrate 110, a connection structural body 140 that is connected with one end of the collected signal wiring 130, and a controller 150 that is connected with the other end of the connection structural body 140 to receive information.

In this configuration, the connection structural body 140 is configured as a flexible printed circuit board (FPCB) and receives signals generated from the transparent electrodes 120 by way of the signal wirings 130 and transmits the received signals to a controller 150.

As illustrated in FIG. 1, the connection structure of the touch panel 100 according to the first preferred embodiment of the present invention will be described in detail below.

First, the transparent substrate 110 will be described.

The transparent substrate 110 has a region in which the transparent electrodes 120, the signal wirings 130, and the like, are formed. Therefore, the transparent substrate 110 needs to have support force to support the transparent electrodes 120, the signal wirings 130, and the like, and transparency for a user to recognize images provided from an image display device. In consideration of the support force and the transparency described above, the transparent substrate 110 may be made of polyethylene terephthalate (PET), polycarbonate (PC), poly methyl methacrylate (PMMA), polyethylene naphthalate (PEN), polyethersulfone (PES), a cyclic olefin polymer (COC), a triacetylcellulose (TAC) film, a polyvinyl alcohol (PVA) film, a polyimide (PI) film, polystyrene (PS), biaxially oriented polystyrene (BOPS; containing K resin), glass, or tempered glass, but is not necessarily limited thereto.

Meanwhile, when being touched by a user, the transparent electrodes 120 generate signals for a controller 150 to recognize touched coordinates. Herein, the transparent electrodes 120 are formed on an upper surface of the transparent substrate 110. In this case, before the transparent electrodes 120 are formed, the upper surface of the transparent substrate 110 is preferably subjected to the high frequency treatment or the primer treatment so as to activate (improve adhesion) the upper surface of the transparent substrate 110. Further, the transparent electrode 120 may be usually formed of indium tin oxide (ITO) and conductive polymer having excellent flexibility and a simplified coating process. In this case, the conductive polymer may be formed of poly-3,4-ethylenedioxythiophene/polystyrenesulfonate (PEDOT/PSS), polyaniline, polyacetylene, polyphenylenevinylene, and the like.

Meanwhile, in the drawings, the transparent electrode 120 has a bar type pattern, which is only an example. Therefore, the transparent electrode 120 may be modified to patterns known in the art, such as a triangular pattern, a diamond pattern, a hexagonal pattern, an octagonal pattern, a mesh pattern, and the like.

The transparent electrodes 120 formed as described above is electrically connected with ends of the signal wirings 130.

Here, the signal wirings 130 serve to transmit the signals received from the transparent electrodes 120 to the controller 150. Therefore, the signal wirings 130 are formed on the transparent substrate 110 and the ends of the signal wirings 130 are connected with the transparent electrodes 120 and the other ends thereof extend so as to connect with one end of the connection structural body 140.

Meanwhile, the other ends of the signal wirings 130 are collected to a connection region A with the connection structural body 140 so as to electrically connect with the connection structural body 140. Here, the signal wiring 130 may be printed by using a silk screen method, a gravure printing method, an inkjet printing method, and the like. In this case, as a material of the signal wiring 130, material composed of Ag paste or organic silver having excellent electrical conductivity may be used, but the present invention is not limited thereto. Therefore, conductive polymer, carbon black (including CNT), metal oxides such as ITO, low resistance metals, and the like, may be used. Further, the connection region A is a region to which the signal wirings 130 are collected and is a region that is connected with the connection structural body 140.

Referring to FIG. 1, the signal wiring 130 is connected with both ends of the transparent electrode 120, which is only an example. Therefore, the signal wiring 130 is connected with one end of the transparent electrode 120 according to the type of the touch panel 100 and another signal wiring is connected with the other end of the transparent electrode 120, such that two connection structural bodies 140 may also be provided.

The connection structural body 140 is formed including the flexible printed circuit board (FPCB), which has an efficient structure for miniaturization and thinness of the touch panel 100.

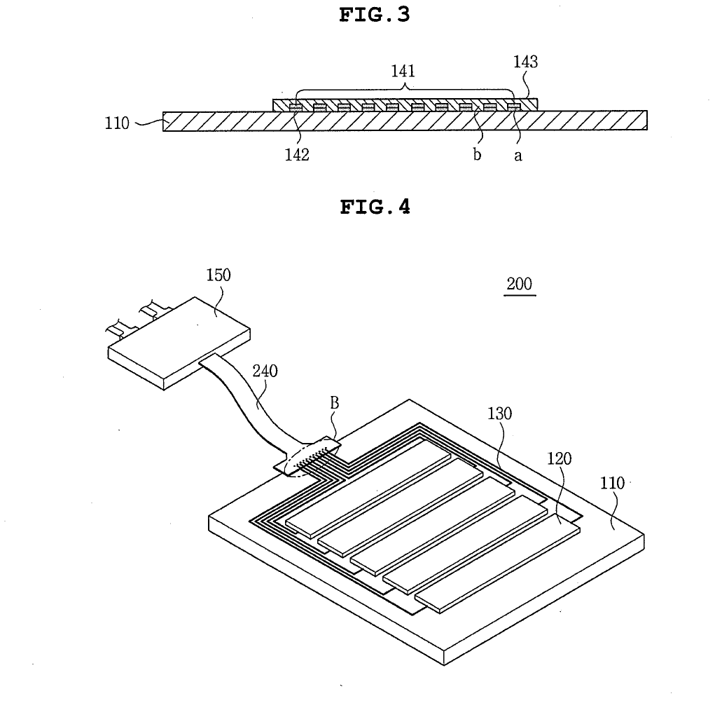

Next, the connection structural body 140 will be described in detail with reference to FIGS. 2 and 3.

FIG. 2 is an exemplified diagram illustrating in detail a connection structural body of a touch panel according to the first preferred embodiment of the present invention and FIG. 3 is a cross-sectional view illustrating a cut surface of the connection structural body of a touch panel according to the first preferred embodiment of the present invention.

Referring to FIGS. 2 and 3, the connection structural body 140 of the touch panel 100 according to the first preferred embodiment of the present invention includes a pad portion 141 in which each pad a is formed in one direction while including a separate space b, an adhesive portion 142 for adhering the pad portion 141 on the transparent substrate 110, and a molding portion 143 formed by applying a molding agent on an upper surface of the pad portion 141.

The connection structural body 140 according to the first preferred embodiment of the to present invention configured as illustrated in FIGS. 2 and 3 will be described below in detail.

First, the connection structural body 140 is formed as the flexible printed circuit board and the connection structural body 140 is provided with the signal wirings (not illustrated) and the signal wirings extend to one end and the other end of the connection structural body 140. The ends of the signal wirings are each provided with pads so as to be electrically connected with the outside. Therefore, the pad may be formed including the conductive materials and the region of the flexible printed circuit board other than the pad may be preferably insulated.

Referring to FIG. 2, the pad portion 141 according to the first preferred embodiment of the present invention is configured so that a plurality of pads a extend in one direction while including the separate space b. Here, the pad a is formed of a conductive material so as to receive an electrical signal.

Further, each pad a is separated at a predetermined interval so as to be insulated. Therefore, the separated region is formed between the respective pads a and the separated region is removed by the stamping process such as punching to form the separate space b.

Here, as the separated region does not have the signal wirings, the separated region is stamped, which does not have an effect on the transmission and reception of signals even though the separate space b is formed in the separated region.

Meanwhile, the pad portion 141 is alternately formed with a plurality of concave and convex shapes and one surface of a convex shape is provided with the pad a.

Here, a lower surface of the pad portion 141 is provided with a conductive adhesive portion 142. The reason is as follows.

The pad portion 141 is received with information sensed by the transparent electrode 120 through the signal wirings 130. Here, the information is an electrical signal. Therefore, the pad portion 141 is electrically connected with the signal wirings 130 so as to transmit and receive the electrical signal, such that the lower surface of the pad portion 141 is provided with the conductive adhesive portion 142.

Here, the adhesive portion 142 is formed of conductive adhesive materials such as an anisotropic conductive film (ACF), an anisotropic conductive adhesive (ACA), and the like, to electrically connect the signal wirings 130 with the pad portion 141.

Meanwhile, the upper surface of the pad portion 141 is provided with a molding portion 143 so as to reinforce the connection of the adhesive portion 142. The molding portion 143 serves to fix the connection structural body 140 on the transparent substrate 110. To this end, the molding portion 143 is formed by applying a molding agent on the upper surface of the pad portion 141.

Here, as the molding agent, epoxy, and the like, may be preferably used. In addition, it is preferable to increase the adhesive strength between the transparent substrate 110 and the connection structural body 140 by forming the molding portion 143 to cover the entire upper surface of the pad portion 141. Therefore, the connection structural body 140 may secure the electrical connection between the transparent substrate 110 and the controller 150 of the touch panel 100.

FIG. 4 is an exemplified diagram illustrating a touch panel according to a second preferred embodiment of the present invention.

Referring to FIG. 4, a touch panel 200 according to a second preferred embodiment of the present invention includes a transparent substrate 110, transparent electrodes 120 formed on an upper surface of the transparent substrate 110, signal wirings 130 that extend from the transparent electrodes 120 and are collected to one end of the transparent substrate 110, a connection structural body 240 that is connected with one end of the collected signal wiring 130, and a controller 150 that is connected with the other end of the connection structural body 240 to receive information.

In this configuration, the connection structural body 240 is configured as a flexible printed circuit board (FPCB) and receives signals generated from the transparent electrodes 120 by way of the signal wirings 130 and transmits the received signals to a controller 150.

As illustrated in FIG. 4, the connection structure of the touch panel 200 according to the second preferred embodiment of the present invention will be described in detail below.

First, the transparent substrate 110 will be described.

The transparent substrate 110 has a region in which the transparent electrodes 120, the signal wirings 130, and the like, are formed. Therefore, the transparent substrate 110 needs to have support force to support the transparent electrodes 120, the signal wirings 130, and the like, and transparency for a user to recognize images provided from an image display device. In consideration of the support force and the transparency described above, the transparent substrate 110 may be made of polyethylene terephthalate (PET), polycarbonate (PC), poly methyl methacrylate (PMMA), polyethylene naphthalate (PEN), polyethersulfone (PES), a cyclic olefin polymer (COC), a triacetylcellulose (TAC) film, a polyvinyl alcohol (PVA) film, a polyimide (PI) film, polystyrene (PS), biaxially oriented polystyrene (BOPS; containing K resin), glass, or tempered glass, but is not necessarily limited thereto.

Meanwhile, when being touched by a user, the transparent electrodes 120 generate signals for a controller 150 to recognize touched coordinates. Herein, the transparent electrodes 120 are formed on an upper surface of the transparent substrate 110. In this case, before the transparent electrodes 120 are formed, the upper surface of the transparent substrate 110 is preferably subjected to the high frequency treatment or the primer treatment so as to activate (improve adhesion) the upper surface of the transparent substrate 110. Further, the transparent electrode 120 may be usually formed of indium tin oxide (ITO) and conductive polymer having excellent flexibility and a simplified coating process. In this case, the conductive polymer may be formed of poly-3,4-ethylenedioxythiophene/polystyrenesulfonate (PEDOT/PSS), polyaniline, polyacetylene, polyphenylenevinylene, and the like.

Meanwhile, in the drawings, the transparent electrode 120 has a bar type pattern, which is only an example. Therefore, the transparent electrode 120 may be modified to patterns known in the art, such as a triangular pattern, a diamond pattern, a hexagonal pattern, an octagonal pattern, a mesh pattern, and the like.

The transparent electrodes 120 formed as described above is electrically connected with ends of the signal wirings 130.

Here, the signal wirings 130 serve to transmit the signals received from the transparent electrodes 120 to the controller 150. Therefore, the signal wirings 130 are formed on the transparent substrate 110 and the ends of the signal wirings 130 are connected with the transparent electrodes 120 and the other ends thereof extend so as to connect with the connection structural body 140.

Meanwhile, the other ends of the signal wirings 130 are collected to a connection region B with the connection structural body 140 so as to electrically connect with the connection structural body 140. Here, the signal wiring 130 may be printed by using a silk screen method, a gravure printing method, an inkjet printing method, and the like. In this case, as a material of the signal wiring 130, material composed of Ag paste or organic silver having excellent electrical conductivity may be used, but the present invention is not limited thereto. Therefore, conductive polymer, carbon black (including CNT), metal oxides such as ITO, low resistance metals, and the like, may be used.

Referring to FIG. 4, the signal wiring 130 is connected with both ends of the transparent electrode 120, which is only an example. Therefore, the signal wiring 130 is connected with one end of the transparent electrode 120 according to the type of the touch panel 100 and another signal wiring is connected with the other end of the transparent electrode 120, such that two connection structural bodies 240 may also be provided.

The connection structural body 240 is formed including the flexible printed circuit board (FPCB), which has an efficient structure for miniaturization and thinness of the touch panel 100.

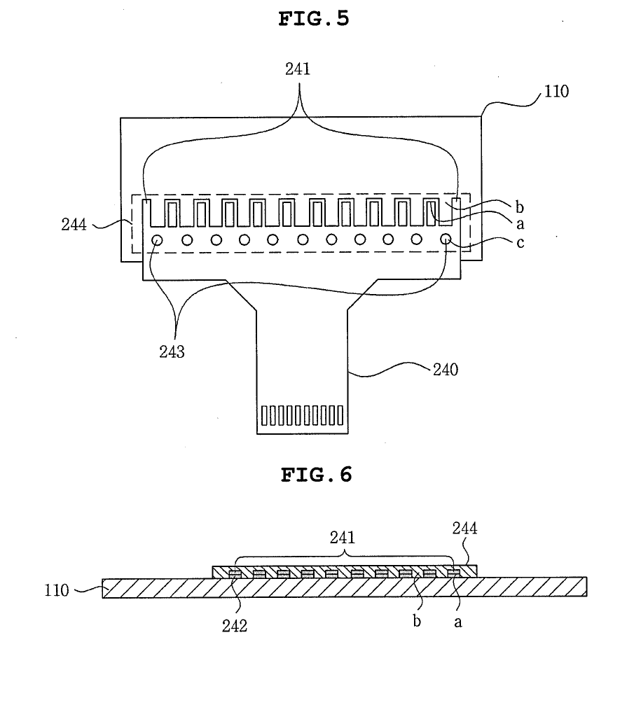

Next, the connection structural body 240 will be described in detail with reference to FIGS. 5 and 6.

FIG. 5 is an enlarged view illustrating in detail a connection structural body according to the second preferred embodiment of the present invention and FIG. 6 is a cross-sectional view illustrating a cut surface of the connection structural body of a touch panel according to the second preferred embodiment of the present invention.

Referring to FIGS. 5 and 6, the connection structural body 240 according to the second preferred embodiment of the present invention includes a pad portion 241 in which each pad a is formed in one direction while including a separate space b, a pattern portion 243 formed at a front end of the pad portion 241 by removing a plurality of patterns, an adhesive portion 242 for adhering the pad portion 241 on the transparent substrate 110, and a molding portion 244 formed by applying a molding agent on upper surfaces of the pad portion 241 and the pattern portion 243.

As illustrated in FIG. 5, the connection structural body 240 according to the second preferred embodiment of the present invention will be described in detail below.

First, the connection structural body 240 is formed as the flexible printed circuit board and the connection structural body 240 is provided with the signal wirings (not illustrated) and the signal wirings extend to one end and the other end of the connection structural body 240. The ends of the signal wirings are provided with pads so as to be electrically connected with the outside. Therefore, the pad may be formed including the conductive materials and the region of the flexible printed circuit board other than the pad may be preferably insulated.

Referring to FIG. 5, the pad portion 241 according to the second preferred embodiment of the present invention is configured so that a plurality of pads a extend in one direction while including the separate space b. Here, the pad a is formed of a conductive material so as to receive an electrical signal.

Further, each pad a is separated at a predetermined interval so as to be insulated. Therefore, the separated region is formed between the respective pads a and the separated region is removed by the stamping process such as punching to form the separate space b.

Here, as the separated region does not have the signal wirings, the separated region is stamped, which does not have an effect on the transmission and reception of signals even though the separate space b is formed in the separated region.

Meanwhile, the pad portion 141 is alternately formed with a plurality of concave and convex shapes and one surface of a convex shape is provided with the pad a.

Meanwhile, the pattern portion 243 is provided at the front end of the pad portion 241. The pattern portion 243 provided as described above has a circular shape and has the removed patterns c that are arranged in a transverse direction.

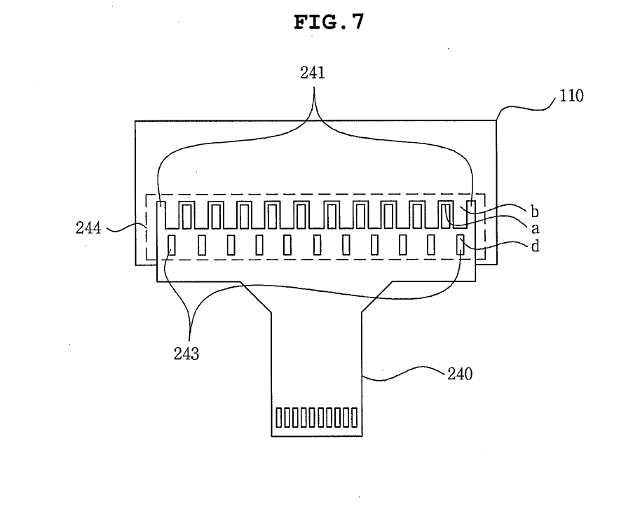

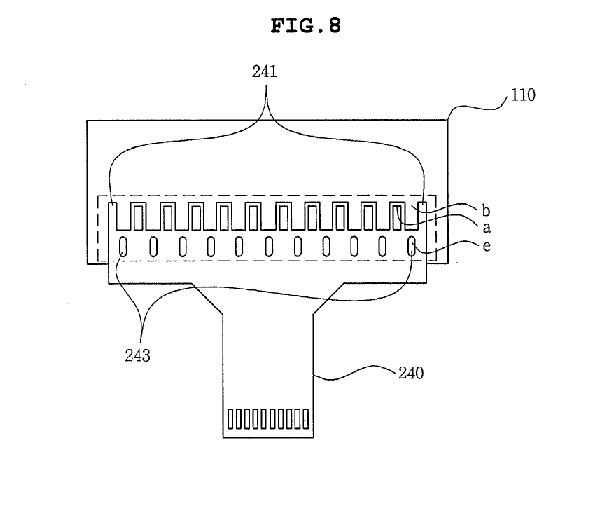

Referring to FIG. 5, the pattern portion 243 is provided at the front end of the pad portion 241. In FIG. 5, the plurality of removed patterns c having a circular shape are named as the pattern portion 243. However, the plurality of circular patterns illustrated in FIG. 5 is only an example. As illustrated in FIG. 7, a pattern portion configured as a plurality of rectangular patterns d that extend vertically and as illustrated in FIG. 8, a pattern portion configured as a plurality of oval patterns e may be applied.

That is, the pattern portion 243 according to the second preferred embodiment of the present invention removes a non-signal region pattern of the flexible printed circuit board in circular, oval, and polygonal shapes within a range that does not affect the transmission and reception of the signal and may be arranged in at least one column in a vertical direction or a horizontal direction.

Referring back to FIG. 6, the lower surface of the pad portion 241 is provided with a conductive adhesive portion 242. The reason why the lower surface of the pad portion 241 is provided with a conductive adhesive portion 242 is as follows.

The pad portion 241 is received with information sensed by the transparent electrode 120 through the signal wirings 130. Here, the information is an electrical signal. Therefore, the pad portion 241 is electrically connected with the signal wirings 130 so as to transmit and receive the electrical signal, such that the lower surface of the pad portion 241 is provided with the conductive adhesive portion 242.

Here, the adhesive portion 242 is formed of conductive adhesive materials such as an anisotropic conductive film (ACF), an anisotropic conductive adhesive (ACA), and the like, to electrically connect the signal wirings 130 with the pad portion 241.

Meanwhile, the upper surfaces of the pad portion 241 and the pattern portion 243 are provided with the molding portion 244 so as to reinforce the connection of the adhesive portion 242. The molding portion 244 serves to fix the connection structural body 240 on the transparent substrate 110. To this end, the molding portion 244 is formed by applying a molding agent on the upper surfaces of the pad portion 241 and the pattern portion 243.

That is, the connection strength between the connection structural body 240 and the transparent substrate 110 may be increased by applying the upper surface of the transparent substrate 110 and the upper surface of the pad portion 241 that are exposed by the pattern portion 243.

Here, as the molding agent, epoxy, and the like, may be preferably used. Further, it is preferable to increase the adhesive strength by forming the molding portion 244 wider than a summed area of the pad portion 241 and the pattern portion 243 so as to cover the entire upper surfaces of the pad portion 241 and the pattern portion 243. Therefore, the connection structural body 240 according to the second preferred embodiment of the present invention may secure the electrical connection between the transparent substrate 110 and the controller 150.

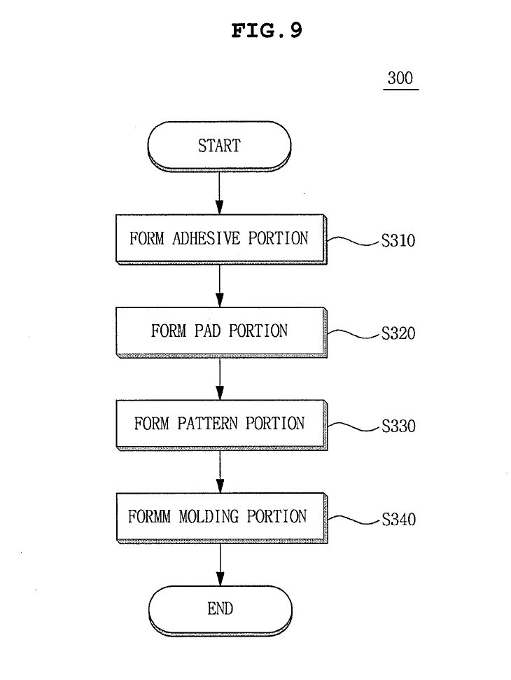

FIG. 9 is a flow chart sequentially illustrating a method of manufacturing a connection structural body of a touch panel according to a third preferred embodiment of the present invention.

Referring to FIG. 9, a method 300 of manufacturing a connection structural body of a touch panel according to the third preferred embodiment of the present invention includes forming the adhesive portion 242 on a lower part of the pad a (S310), forming the pad portion 241 by stamping a separated region between the respective pads a (S320), and forming the molding portion 244 by applying a molding agent on the upper surface of the pad portion 241 (S340).

As illustrated in FIG. 9, the method of manufacturing a connection structural body of a touch panel according to the third preferred embodiment of the present invention will be described in detail below.

First, the lower part of the pad a is formed with the adhesive portion 242 (S310).

The adhesive portion 242 is formed of conductive adhesive materials such as an anisotropic conductive film (ACF), an anisotropic conductive adhesive (ACA), and the like, to electrically connect the signal wirings 130 with the pad portion 241.

Next, the pad portion 241 is formed by stamping the separated region between the respective pads a (S320). The separated region is removed by the stamping process such as punching and thus is a region in which the separate space b is formed.

Here, as the separated region does not have the signal wirings, the separated region is stamped, which does not have an effect on the transmission and reception of signals even though the separate space b is formed in the separated region.

Further, the anisotropic conductive film or the anisotropic conductive adhesive formed on the lower surface of the separated region is removed by the stamping process.

The pad portion 241 formed as described above has a shape in which the plurality of concave shapes and convex shapes are alternately formed. One surface of the convex shape is provided with the pad a.

Next, the pattern portion 243 is formed (S330).

The pattern portion 243 is formed at the front end of the pad portion 241 by removing the plurality of patterns c and is formed on the lower surface of the molding portion 244 so as to be covered by the molding portion 244.

Here, the pattern c has a circular shape, but may have a rectangular d or oval e shape within a range that does not affect the transmission and reception of the signal and may be formed in a polygonal shape.

Further, the pattern is formed in a vertical or horizontal direction, but may be formed in at least one column.

Finally, the molding portion 244 is formed by applying a molding agent on the upper surface of the pad portion 241 and the pattern portion 243.

The molding portion 244 serves to fix the connection structural body 240 on the transparent substrate 110. To this end, the molding portion 244 is formed by applying the molding agent on the upper surfaces of the pad portion 241 and the pattern portion 243.

As the molding agent, the epoxy is used. The connection strength between the connection structural body 240 and the transparent substrate 110 may be increased by applying the upper surface of the transparent substrate 110 and the upper surface of the pad portion 241 that are exposed by the pattern portion 243.

Further, the molding agent may also be applied on the upper surface of the separate space a to increase the connection strength between the connection structural body 240 and the transparent substrate 110.

The connection structural body 240 may be manufactured and applied as in the third preferred embodiment of the present invention to secure the electrical connection between the transparent substrate 110 and the controller 150 of the touch panel 200.

According to various preferred embodiments of the present invention, it is possible to improve the bonding strength of the flexible printed circuit board in the touch pad.

Further, according to various preferred embodiments of the present invention, it is possible to prevent the disconnection and short of the signal line by providing the flexible printed circuit board strong against the physical impact from the outside.

Therefore, according to various preferred embodiments of the present invention, it is possible to contribute to the miniaturization and thinness of the touch panel while improving the durability of the touch pad.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A connection structural body of a touch panel, comprising:
a pad portion connected with one portion of the touch panel and having each pad formed in one direction while including a separate space;
an adhesive portion formed on a lower surface of the pad portion; and
a molding portion formed on an upper surface of the pad portion.

2. The connection structural body of a touch panel as set forth in claim 1, wherein the connection structural body is a flexible printed circuit board (FPCB).

3. The connection structural body of a touch panel as set forth in claim 1, wherein the pad portion is alternately formed with a plurality of concave and convex shapes, and
one surface of the convex shape is provided with the pad.

4. The connection structural body of a touch panel as set forth in claim 1, wherein the pad portion is formed of a conductive material.

5. The connection structural body of a touch panel as set forth in claim 1, wherein the adhesive portion uses an anisotropic conductive film (ACF) or an anisotropic conductive adhesive (ACA).

6. The connection structural body of a touch panel as set forth in claim 1, wherein the molding portion is formed of epoxy.

7. The connection structural body of a touch panel as set forth in claim 1, wherein the molding portion is formed wider than an area of the pad portion so as to cover the entire upper surface of the pad portion.

8. The connection structural body of a touch panel as set forth in claim 1, further comprising a pattern portion formed at an end of the pad portion and formed in a plurality of patterns.

9. The connection structural body of a touch panel as set forth in claim 8, wherein the pattern has a circular or oval shape.

10. The connection structural body of a touch panel as set forth in claim 8, wherein the pattern has a polygonal shape.

11. The connection structural body of a touch panel as set forth in claim 8, wherein the pattern is formed vertically or horizontally and is formed in at least one column.

12. A method of manufacturing a connection structural body of a touch panel, comprising:
(A) forming an adhesive portion on a lower portion of a pad;
(B) forming a pad portion by stamping a separate region between the respective pads; and
(C) forming a molding portion by applying a molding agent on an upper surface of the pad portion.

13. The method as set forth in claim 12, wherein in the forming of the adhesive portion, the adhesive portion uses an anisotropic conductive film (ACF) or an anisotropic conductive adhesive (ACA).

14. The method as set forth in claim 12, wherein in the forming of the pad portion, the pad portion is alternately formed with a plurality of convex shapes in which the pad is formed and a plurality of concave shape in which the space region is stamped.

15. The method as set forth in claim 12, wherein the forming of the pad portion further includes forming the pattern portion at a front end of the pad portion by removing the plurality of patterns and forming the pattern portion on a lower surface of the molding portion so as to be covered by the molding part.

16. The method as set forth in claim 15, wherein the pattern has a circular or oval shape.

17. The method as set forth in claim 15, wherein the pattern has a polygonal shape.

18. The method as set forth in claim 15, wherein the pattern is formed vertically or horizontally and is formed in at least one column.
